(19) United States
(12) Patent Application Publication
(10) Pub. No.: US 2004/0059689 A1
(43) Pub. Date: Mar. 25, 2004

(54) Check presentation system

(76) Inventor: Josh Masden, Tucson, AZ (US)

Correspondence Address: Steven Thrasher, 391 Sandhill Dr., Richardson, TX, 75080, US

(21) Appl. No.: 10/252,248

(22) Filed: Sep. 20, 2002

(51) Int. Cl. G06F 17/00

(52) U.S. Cl. 705/400

(57) ABSTRACT

The invention is a check presentation system. Typically the check presentation system includes a bill folder having a bill pocket for holding a bill, and a tip calculator coupled to the bill folder. Accordingly, patrons need not be embarrassed by fumbling with simple math, waiters and other service workers can more reliably receive tips, and tipping can be more reliably monitored.

### TECHNICAL FIELD

The present invention relates to the services industry, and more particularly the invention relates to transactions that typically involve tipping.

### STATEMENT OF A PROBLEM ADDRESSED BY THIS INVENTION

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Statement of a Problem Addressed by This Invention is to be construed as prior art.

Discussion

Many persons are dependent upon gratuities (or tips) for a significant portion of their livelihood, particularly in industries where tipping is expected. For example, it is common for some persons, such as certain restaurant workers, to work for “tips only.” These persons depend on patrons tipping certain industry-standard amounts, such as 15% in the restaurant industry. Similarly, many persons who want to tip are unsure how much to tip, or even how to calculate a tip because of simple mathematical ignorance—this also can lead to social embarrassment. Furthermore, the Internal Revenue Service (IRS) looses millions of dollars of revenue each year due to under—reported income due to the lack of tip reporting guarantees that exist. Workers could benefit from systems that easily determine proper tipping amounts, patrons could avoid the social stigma associated with “shorting” a service worker, and the IRS could recover lost revenue if these persons had a reliable way to calculate and track a tip. Accordingly, there is a need for such a system.

Additionally, when a person receives a bill at a restaurant or other service provider (called “the check presentation”), the service provider has a uniquely captive audience. Accordingly, it would be beneficial for the service provider to be able to deliver a targeted message to a patron at the time of a check presentation. Accordingly, there are benefits associated with a system that generates a targeted purchaser message at the time of the check presentation.

### SELECTED OVERVIEW OF SELECTED EMBODIMENTS

The present invention achieves technical advantages as check presentation systems. Typically the check presentation system includes a bill folder having a bill pocket for holding a bill, and a tip calculator coupled to the bill folder. Alternative embodiments of the invention may provide additional features such as electronic advertisements, or backlights. Accordingly, patrons need not be embarrassed by fumbling with simple math, waiters and other service workers can more reliably receive tips, and tipping can be more reliably monitored.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention, and it should be understood that the invention is not limited by the detailed description. Accordingly, the invention should be read as being limited only by the claims.

### BRIEF DESCRIPTION OF THE DRAWINGS

Various aspects of the invention, as well as at least one embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 illustrates a check presentation system;

FIG. 2 provides a block diagram of the tip calculator; and

FIG. 3 shows an alternative embodiment of a check presentation system.

### AN EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”). Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the Claims section.

Discussion of the Figures

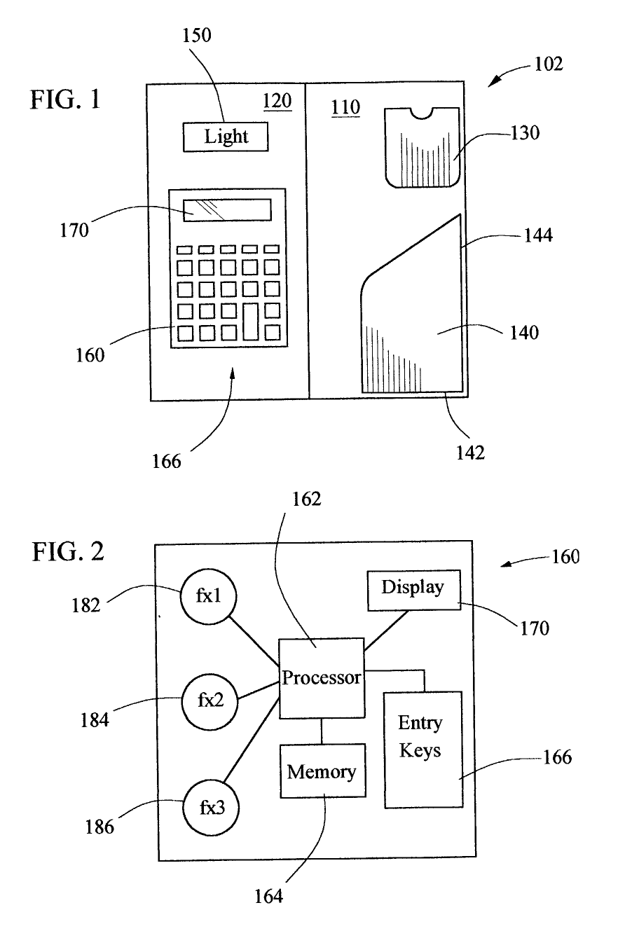

Features and advantages of the invention can be better understood by reviewing FIG. 1, which illustrates a check presentation system 100 according to the teachings of the invention. The check presentation system 100 is open to show the inside of the check presentation system 100, which includes a bill folder having a back panel 110 and a front panel 120. The back panel has a bill pocket 140 for holding a bill, and a tip calculator 160 coupled to the bill folder front panel 120. The bill pocket 140 is large enough to hold a receipt, and is thus at least two inches wide by two inches high, and the bill pocket is integral with an inside portion of the bill folder at a bottom crease 142 and an outside crease 144. Similarly, a credit card pocket 130 is also coupled to the inside portion of the back panel 130. The credit card pocket 130 and the bill pocket 140 are well known in the art of check presentation folders.

A tip calculator 160 having numeric and function keys 166 (keys 166) presents a patron with plurality of tipping choices, and adds a selected tipping choice to the bill when a tipping choice is selected. In addition, in one embodiment the tip calculator 160 also allows a patron to easily divide a bill amongst a plurality of persons. Of course, the tip calculator 160 need not be fully functional, and only needs to offer a patron the ability to add a tip to a bill. So that a patron may more easily use the tip calculator 160 in darker restaurants, a light 150 is provided in a preferred embodiment. The light is preferably a light emitting diode (LED) that throws a light directionally on the tip calculator 160. In addition, the tip calculator provides a display 170, which is described in more detail below.

FIG. 2 provides a block diagram of the tip calculator 160, generally comprising a memory 164 coupled to a processor 162, which is also coupled to numeric keys 166 and a display 170. From FIG. 2 one can see that the tip calculator 160 preferably comprises at least one function key coupled to the tip calculator, and in the present embodiment provides a first function key 182, a second function key 184, and a third function key 186. The function keys provide a patron quick access to common computations, such as calculating a tip of 10%. For a more specific example, in a preferred embodiment, the first function key 182 calculates a 15% tip, the second function key 184 calculates a 20% tip and the third function key 186 calculates a taxable amount. Of course, additional functions can be selected, such as a “brighten light” function, a display

The processor 162 is any processor capable of mathematical computations, such as a digital signal processor (DSP, which may be programmable), a computer processor, or a traditional calculator processor. In a preferred embodiment, the processor 162 is a programmable DSP. Of course, a power source, such as a battery or a solar panel, is coupled to the tip calculator to provide the needed voltage to the various devices. Additional functionality is provided to the processor via the memory 164. The memory 164, which may be any form of volatile or non-volatile memory, can store mathematical and other functions for assignment to the function keys 182, 184, and 186, and may store electronic advertisements for display to a patron via the display 170. In another preferred embodiment, the processor is adapted to wirelessly receive data.

The display 170 is any display capable of presenting a patron with information. For example, the display may be a plasma screen display, a liquid crystal display, or an organic diode display. If the display is of a type that is not self-illuminating, then it is preferred to provide a backlight with the display 170 (since backlighting a display is known, it is not shown in FIG. 2).

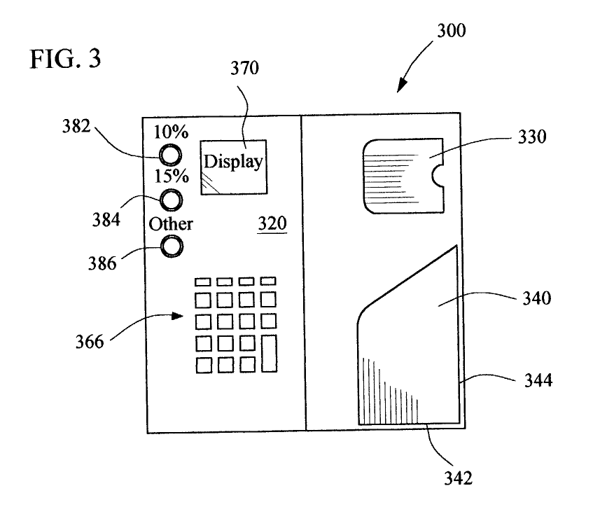

Of course, there are many variations to the invention which will be readily apparent to those of ordinary skill in the art, and these are incorporated into the invention without departing from the scope of the claims. For example, FIG. 3 shows an alternative embodiment of a check presentation system 300. The check presentation system 300 has a credit card pocket 330, a bill pocket 340, and a bill calculator. However, the bill calculator is not shown in FIG. 3 since it lies underneath a covering on a front panel 320 of the check presentation folder. Rather keys 366 are either integrally formed on the front panel 320, or the keys 366 individually protrude the front panel 320. In other words, in an alternative embodiment the tip calculator has entry keys 366 and is integrated into the front panel 320 such that only the entry keys 366 of the tip calculator are individually visible through the front panel 320. Of course, it should be understood that although the discussion herein describes entry keys 366 on the “inside” of a bill folder, it is understood that the entry keys 366, display 370, or any other portion of the check presentation system may be on either an inside or an outside of a front panel, or a back panel, as the invention is limited only by the claims.

Thus, though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A check presentation system, comprising:
a bill folder having a bill pocket for holding a bill; and
a tip calculator coupled to the bill folder.

2. The check presentation system of claim 1 wherein the bill pocket is at least two inches by two inches, and the bill pocket is integral with an inside portion of the bill folder.

3. The check presentation system of claim 1 wherein the tip calculator presents a patron with plurality of tipping choices, and adds a selected tipping choice to the bill when a tipping choice is selected.

4. The check presentation system of claim 1 further comprising at least one function key coupled to the tip calculator.

5. The check presentation system of claim 1 wherein the tip calculator is adapted to wirelessly receive data.

6. The check presentation system of claim 1 wherein the tip calculator comprises:
a memory coupled to the processor;
a numeric key coupled to the processor; and
a display coupled to the processor.

7. The check presentation system of claim 6 wherein the memory electronically stores an advertisement for display to a patron.

8. The check presentation system of claim 6 wherein is a plasma screen display.

9. The check presentation system of claim 6 wherein the display is a liquid crystal display.

10. The check presentation system of claim 6 wherein the display is an organic diode display.

11. The check presentation system of claim 1 wherein the tip calculator has entry keys and is integrated into the bill folder such that only the entry keys of the tip calculator are individually visible through the bill folder.

12. The check presentation system of claim 1 further comprising a light disposed in the bill folder.

13. The check presentation system of claim 1 further comprising a power source coupled to the tip calculator.

14. The check presentation system of claim 12 wherein the light is generated by a light emitting diode.

15. The check presentation system of claim 12 wherein the display comprises a backlight.

16. The check presentation system of claim 6 wherein the first function key automatically calculates a 10% tip.

17. The check presentation system of claim 6 wherein the first function key automatically calculates a 15% tip.

18. The check presentation system of claim 1 further comprising a credit card pocket.
